(19) United States
(12) Patent Application Publication
(10) Pub. No.: US 2021/0156808 A1
(43) Pub. Date: May 27, 2021

(54) APPARATUS FOR VISUALLY INSPECTING RESIDENTIAL AND COMMERCIAL CHIMNEYS

(71) Applicant: Universal Chimney Lining, Inc., Paoli, PA (US)

(72) Inventor: Isaac Windle, Paoli, PA (US)

(21) Appl. No.: 17/099,410

(22) Filed: Nov. 16, 2020

Related U.S. Application Data
(60) Provisional application No. 62/938,581, filed on Nov. 21, 2019.

(51) Int. Cl. G01N 21/954; G01N 21/88; G02B 23/24

(52) U.S. Cl. CPC G01N 21/954; G02B 23/2484; G01N 21/8803

(57) ABSTRACT

A device for visually inspecting one or more internal side walls of a chimney to detect a defect or a deposit. The device includes a protective shell for containing a camera. The protective shell includes an observation bore and a light source bore, which are covered with a transparent shield. A cap is positioned above the protective shell and a positioning assembly is disposed on the cap to maintain a predetermined distance between the interior wall of the chimney and the protective shell. The positioning assembly includes at least three non-rigid rods that extend radially from the cap and are positioned equidistantly about the cap. A clamping mechanism is positioned beneath the housing for clamping to an elongated extension rod to enable controlled raising and lowering of the device within the chimney.

This application claims the benefit of U.S. Provisional Application No. 62/938,581, having a filing date of Nov. 21, 2019, which is incorporated by reference as if fully set forth.

### BACKGROUND

This invention relates to apparatus for inspecting vertically erected structures such as residential and commercial fireplace chimneys where creosote may be deposited. Creosote is a highly combustible material that is driven out of wood or wood products during the burning process in the form of a gas. When the burning efficiency of a fireplace or stove is low, the creosote does not ignite and passes into the chimney flue. As the relatively hot gases pass over the cooler chimney surfaces, the creosote condenses on the chimney walls. After a period of time, the creosote coating will build up to a level that can affect the chimney draw and present a fire hazard. If left unchecked, this highly combustible material will ignite producing extremely intense heat capable of cracking the chimney and spreading to surrounding structures thereby endangering both life and property.

The safest method of preventing chimney fires is to visually inspect the inside of the chimney on a regular basis and clean the chimney when the creosote build-up reaches about one quarter inch in depth. Typically, visual inspection of the chimney heretofore required that access be gained to the lower part or upper part of the chimney either through the flue opening or an access door.

It is known to perform a video scan of a chimney flue to determine if there are defects on the interior surfaces of the chimney walls. Camera systems for the purpose of inspecting chimneys, sewers, building ducts, piping, wells, and power plants are well known. Such camera systems often are quite sophisticated and provide versatility for use in many different applications, as described above. However, such camera systems are often quite expensive and are costly to repair in the event a component fails. Also, such camera systems do not provide the freedom of movement in three-dimensional space needed to conduct a thorough inspection of a residential or commercial chimney. Such systems are expensive because they may include costly waterproof and high resolution cameras, high-grade LED illumination sources, push cables made of expensive materials, color LCD monitors built into an ABS engineering cases, keyboards for text input, and rechargeable battery packs. Such systems may also include costly robotic vision and motion capabilities where environments are hazardous. Such systems can be quite expensive, in many cases costing several thousand dollars, and may provide features and versatility that are unnecessary for many commercial and residential chimney inspections. Also, such available camera systems are often not of a modular construction to enable removal and replacement of failed components with readily available substitute components. Due to the expensive nature of these systems, they are often beyond reach for individuals and small companies providing professional services relating to the inspection of residential and commercial chimneys. Also, such systems may provide features and capabilities that are not needed for many commercial and residential chimney inspections.

It can be seen from the above that a need exists for a system for inspecting a chimney that is lower in cost and more affordable to individuals and small companies that provide professional chimney services including chimney inspection. Also, there is a need for such a system that is modular, wherein in the event a component fails, the component can readily be removed and replaced with an off-the-shelf component, without the need for replacing the entire system.

As will be explained in greater detail below, the present invention addresses these needs by providing a low-cost chimney inspection device that incorporates low cost, off-the-shelf readily available components such as wireless industrial endoscope cameras (or borescope cameras) and light emitting diode (LED) light sources to arrive at a modular system. The present invention provides a shell in which these components may be housed to protect them from dust during use in residential and commercial chimney inspections. In the event of a failure, the components are readily removable for replacement, thus eliminating the need for purchasing an entire new system, which can be prohibitively expensive. The invention will bring chimney inspection cameras within reach of a market segment that heretofore found such devices to be unaffordable.

In addition, the invention is flexible in that it is arranged to accept components having different shapes and sizes, e.g., a cylindrically-shaped camera versus a camera having a square or triangular cross-section. Finally, the protective shell of the present invention is provided with alternative mounting positions to improve freedom of movement in three-dimensional space to enable a thorough inspection of a residential or commercial chimney.

### SUMMARY

In one aspect of the invention, there is provided a device for visually inspecting one or more internal side walls of a chimney to detect a defect or a deposit. The device includes a protective shell for containing a camera. The protective shell includes an observation bore and a light source bore, both of which are covered with a transparent shield. A cap is positioned above the protective shell and a positioning assembly is disposed on the cap to maintain a predetermined distance between the interior wall of the chimney and the protective shell. The positioning assembly includes at least three non-rigid rods that extend radially from the cap and are positioned equidistantly about the cap. A clamping mechanism is positioned beneath the housing for clamping to an elongated extension rod to enable controlled raising and lowering of the device within the chimney.

### BRIEF DESCRIPTION OF THE DRAWINGS

The invention will be described in conjunction with the following drawings in which like reference numerals designate like elements and wherein:

FIG. 1 is a perspective assembly view of the chimney inspection device of the present invention;

FIG. 2 is a front elevational assembly view of the chimney inspection device of the present invention;

FIG. 3 is a side elevational assembly view of the chimney inspection device of the present invention;

FIG. 4 is a rear elevational assembly view of the chimney inspection device of the present invention;

FIG. 5 is a perspective view of the protective shell portion of the chimney inspection device of the present invention;

FIG. 6 is a front elevational view of the protective shell portion of the chimney inspection device of the present invention;

FIG. 7 is a side elevational view of the protective shell portion of the chimney inspection device of the present invention;

FIG. 8 is a side elevational view of the protective shell portion of the chimney inspection device of the present invention;

FIG. 9 is a perspective view of the cap portion of the chimney inspection device of the present invention;

FIG. 10 is a side elevational view of the cap portion of the chimney inspection device of the present invention;

FIG. 11 is a side elevational view of the cap portion of the chimney inspection device of the present invention;

FIG. 12 is a top view of the cap portion of the chimney inspection device of the present invention;

FIG. 13 is a perspective view of the rod mount portion of the chimney inspection device of the present invention;

FIG. 14 is a front elevational view of the rod mount portion of the chimney inspection device of the present invention;

FIG. 15 is a side elevational view of the rod mount portion of the chimney inspection device of the present invention;

FIG. 16 is a bottom view of the rod mount portion of the chimney inspection device of the present invention;

FIG. 17 is a perspective view of an insert portion of the chimney inspection device of the present invention; and

FIG. 18 is an elevational view of the insert portion of the chimney inspection device of the present invention.

### DETAILED DESCRIPTION

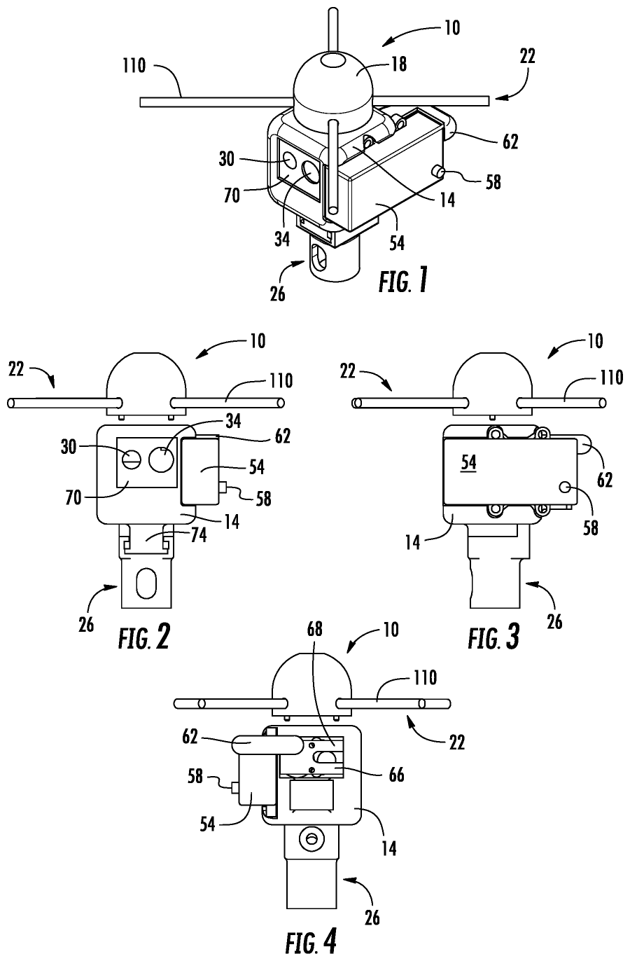

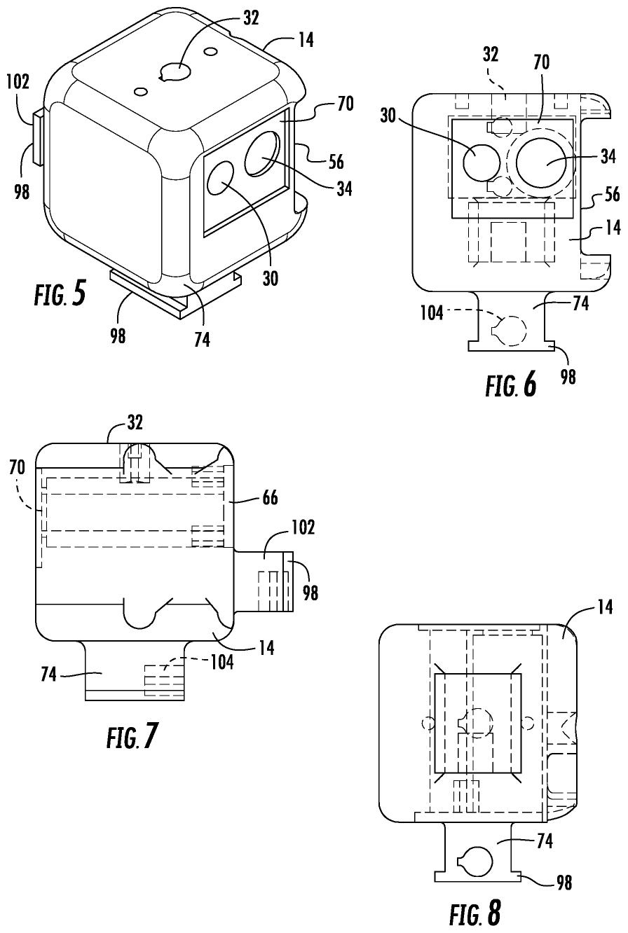

Referring now to FIGS. 1-4, various views of the chimney inspection device 10 of the present invention are shown. The chimney inspection device 10 includes three main components: (1) a protective shell 14 for housing a camera (not shown) and a supplemental light source (not shown), (2) a cap 18 for attachment to the protective shell 14 and having a positioning assembly 22 disposed thereon, and (3) a rod mount 26 positioned beneath the protective shell 14. The positioning assembly 22 is provided to prevent the chimney inspection device 10 from colliding with the walls of the chimney during an inspection. The rod mount 26 is provided for attaching to an extension rod (not shown) to enable controllable raising and lowering of the chimney inspection device 10 within a generally vertical erected structure, such as a residential or commercial chimney.

Referring now to FIGS. 1 through 8, the protective shell 14 is shown therein as being provided in the general form of a cube having four side faces, a top face and a bottom face. However, this shape is merely exemplary, and the protective shell 14 could be provided in other shapes, e.g., a sphere. The protective shell 14 includes two through bores, an observation bore 30 and a light source bore 34, each bore extending entirely through the protective shell 14 and having openings at each end. The observation and light source bores 30 and 34 may extend in a direction that is generally parallel to one another and may be of equal or unequal diameter. For example, the observation bore 30 is arranged for housing an endoscope camera (not shown) therein, such as a wireless endoscope camera. As an alternative to an endoscope camera, a borescope camera may be utilized without departing from the scope of the invention. The endoscope camera (or borescope camera) may be wirelessly connected to a smart phone (not shown) for transmittal of images. Such endoscope cameras (or borescope cameras) are readily available in the marketplace from a number of sources. The endoscope or borescope camera may or may not include a light source. One such suitable wireless endoscope camera is available for sale online at https://gadbe.com/products/wireless-endoscope-inspection-camera-hd-1200p-viaterproof?vaiiant=29447003406389&gclid=EAlalQobOhMlgvygofTJ5QIVj56Ch0blgaxEAkYASABEqLJ5, PD_BwE. Alternatively, the camera may be inserted within a sleeve 38 (FIG. 17), which, in turn, is arranged for insertion within the observation bore 30. As best shown in FIGS. 17 and 18, the sleeve 38 is cylindrical in shape so as to fit snugly within the observation bore 30. In addition, the sleeve 38 may include a plurality of internal steps 42, 46 and 50, which progressively narrow the interior of the sleeve 38. In this manner, the sleeve 38 is arranged to accommodate endoscope cameras (or borescope cameras) of varying shape and size that are readily available but may differ in cross-sectional size and cross-sectional shape, e.g., round, square, oval, triangular, etc.

In the event the camera is not provided with its own light source, the light source bore 34 is provided for housing a supplemental light source. The light source bore 34 is shown as being of a slightly larger diameter than the observation bore 30 to accommodate a suitable light source (not shown) therein. The supplemental light source (not shown) may be provided in the event the wireless endoscope camera (or borescope camera) is not provided with its own light source, or in the event added illumination is desired or required. The supplemental light source can be any suitable light source, such as an LED light source, and such light sources are readily available in the marketplace from a number of sources. One such suitable light source is available for sale online at https://www.superbrightleds.com/moreinfo/flashlight-bulbs/1-watt-flashlight-bulb/373/113/. Similar to the sleeve 38, a cylindrical shaped light insert 38 may be provided which is arranged for snug insertion within the light source bore 34. The light insert 38 is provided for housing a variety of light sources that are readily available but may vary in size and/or shape. As best shown in FIGS. 17 and 18, the light insert 38 is cylindrical in shape so as to fit snugly within the observation bore 30. In addition, the light insert 38 may include a plurality of internal steps 42, 46 and 50, which progressively narrow the interior of the sleeve 38. In this manner, the light insert 38 is arranged to accommodate a sufficiently powerful light source, such as a LED bulb, and associated casings of varying shapes and sizes that are readily available but may differ in cross-sectional size and cross-sectional shape, e.g., round, square, oval, triangular, etc. In the event the light source fails, the light insert 38 is readily removable from the bore to enable removal and replacement of the light source.

The supplemental light source may be connected by wires which extend from the rear of the supplemental light source and outside of the light source bore 34 and run to a power source such as a battery pack 54. The battery pack 54 may include an on/off power button 58. The protective shell 14 may provide a groove 56 or an indentation for retaining the battery pack and the battery back 54 may be retained against the protective shell 14 by any suitable means, e.g., by gluing, and/or by a retention clamp 62. Once the camera and the supplemental light source have been inserted within their respective bores 30 and 34, either with or without utilizing the sleeve 38 to achieve a snug fit, a retention plate 66 may be fastened to the rear of the protective shell 14 over the observation and light source bores 30, 34 by any suitable means, e.g., suitable fastening hardware such as screws. The retention plate 66 may include a U-shaped opening 68 to allow a wire from the endoscope camera (or borescope camera) to pass through. In this manner, the camera and the supplemental light source may be retained within the protective shell 14 and utilized during the inspection of a residential or commercial chimney. The retention plate 66 may be integral with the retention clamp 62. For example, a unitary piece of plastic may be molded to serve both functions, but this is not a requirement. At the opposite end, the observation and light source bores 30, 34 are covered with a protective lens 70 which is transparent and generally rectangular in shape. The front of the protective shell 14 may be provided with a groove for retaining the protective lens 70 in place, and the protective lens 70 may be affixed to the protective shell 14 by any suitable means, e.g., fastening hardware or gluing. The camera and the supplemental light source face the protective lens 70 which protects the camera and supplemental light source from harmful elements within the chimney. The protective shell 14 is resistant to the entry of dust therein so as to protect the camera (not shown) and supplemental light source (not shown) housed therein during inspection of residential or commercial chimneys.

On the bottom face of the protective shell 14, there is provided a horizontal mounting head 74 arranged for mounting to a mounting receptacle 78 disposed on a rod mount 26. The mounting receptacle 78 is formed of a bottom wall 86, a pair of opposed side walls 90, and top walls 94 that together form a groove. The horizontal mounting head 74 includes a laterally extending flange portion 98 arranged for sliding insertion within the groove of the mounting receptacle 78 to join the protective shell 14 to the rod mount 26. In addition the rod mount 26 is provided with a through opening 100 to enable attachment of the rod mount 26 to the protective shell 14. In particular, a set screw (not shown) may pass and through a tension washer (not shown), and through the opening 100, and into a threaded opening 104 on the horizontal mounting head 74 to secure the rod mount 26 to the protective shell 14.

A vertical mounting head 102 is located on a side face of the protective shell 14, and is positioned at an angle of approximately 90 degrees with respect to the horizontal mounting head 74. The location of the vertical mounting head 102 is exemplary only. Alternatively, the vertical mounting head 102 may be located on any other side face of the protective shell 14, so long as it is positioned at an angle of 90 degrees with respect to the horizontal mounting head 74 located on the bottom face of the protective shell 14. Like the horizontal mounting head 74, the vertical mounting head 102 is provided with a flange 98 arranged for sliding insertion within the groove of the mounting receptacle 78 to fasten the protective shell 14 to the rod mount 26. In this manner, utilizing the horizontal mounting head 74, the protective shell 14 may be mounted to the rod mount 26 with the camera and supplemental light source positioned to face horizontally towards the chimney wall. Alternatively, utilizing the vertical mounting head 102, the protective shell 14 may be mounted to the rod mount 26 so that the camera and supplemental light source are positioned facing vertically towards the top or bottom of the chimney depending upon whether the device 10 is inserted from below or above the chimney. In this manner, a degree of flexibility is provided depending upon whether the user intends to inspect the chimney wall or chimney passageway.

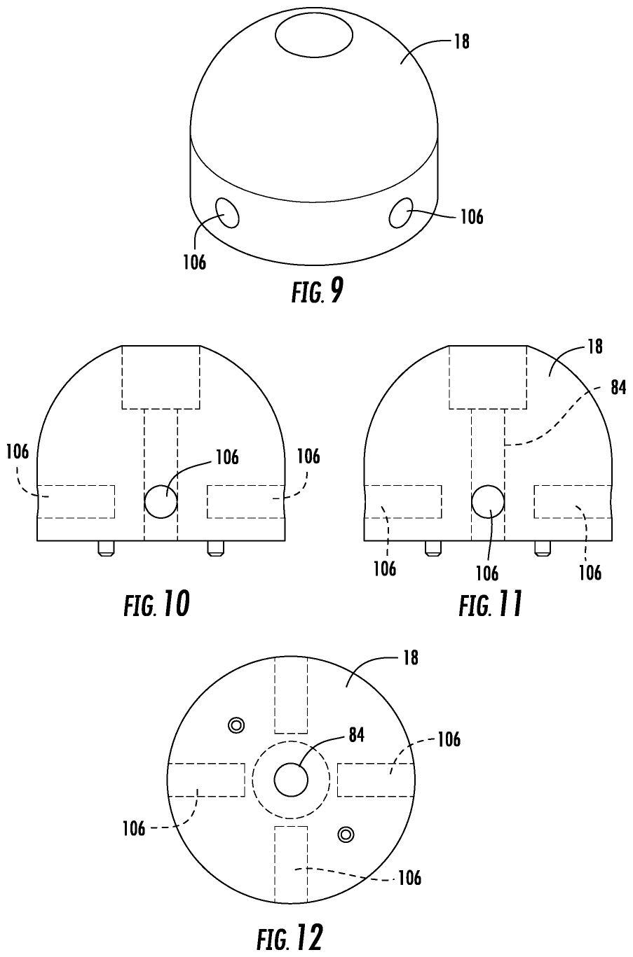

Referring now to FIGS. 1-4 and 9-12, the top cap 18 is provided generally in the shape of a hemisphere. The top cap is arranged to attach to the protective shell 14 and includes a central opening 84 through which a single threaded set screw (not shown) may pass and through a tension washer (not shown) to attach the top cap 18 to the protective shell 14, which also includes a centrally-located opening 32 that is threaded. The top cap 18 includes a plurality of circular openings 106, e.g., three openings, or alternatively, four openings 106, that are spaced equidistantly about the circumference of the cap 18. Each opening 106 is provided for receiving therein an arm 110, which is a round, non-rigid rod, which can be of any suitable length as needed for this application. Together, the arms 110 form the positioning assembly 22 that is provided to ensure that a predetermined distance is maintained between the protective shell 14 and the interior wall of the chimney. In this manner, the positioning assembly 22 prevents the protective shell 14 from colliding with the chimney interior wall and potentially damaging the camera and/or light source housed therein. The positioning assembly 22 may include three arms 110 positioned equidistantly around the circumference of the cap, i.e., at 120° spaced intervals, or may include four arms 110 positioned equidistantly at 90° spaced intervals about the cap circumference, or may include any other suitable number of arms equidistantly spaced about the cap circumference. The arms 110 may be formed of any suitable material that is non-rigid, e.g., a non-rigid or flexible plastic or rubber. The arms 110 may be of any suitable thickness, e.g., from ⅝ to ¾ inches. The arms 110 may be fastened within the openings 106 by threaded engagement, gluing, or any other suitable fasteners. The top cap 18 provides added protection for the device 10 as it navigates through the interior space being inspected.

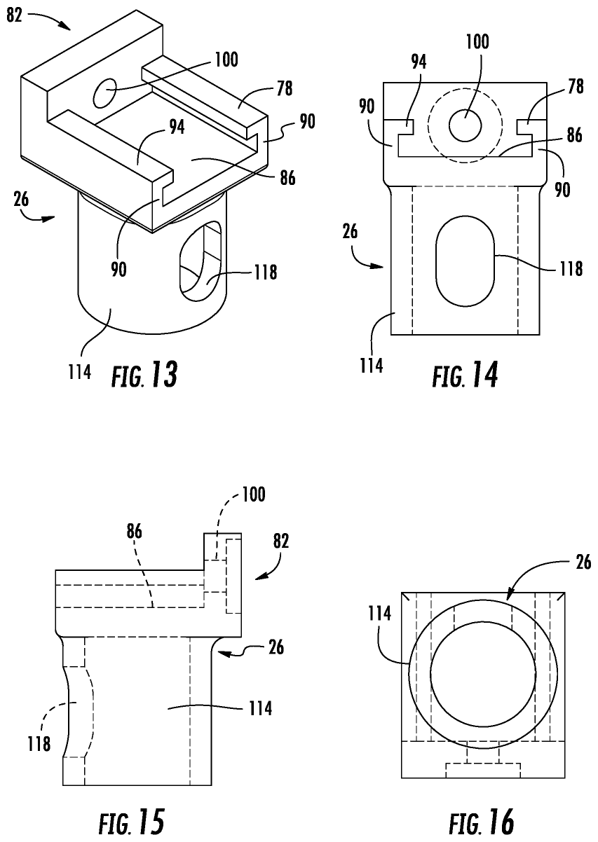

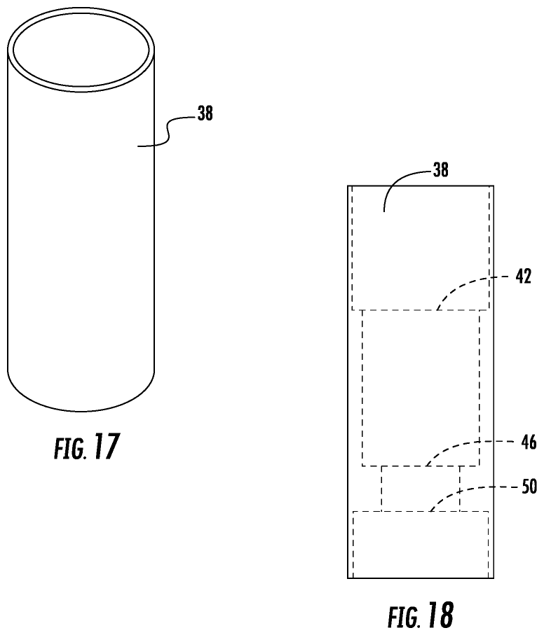

Referring now to FIGS. 1-4 and 13-16, the rod mount 26 is arranged for connecting to an elongated flexible rod (not shown) to enable insertion of the chimney inspection device 10 into the chimney from below or above. In particular, the rod mount 26 includes a cylindrical member 114 having an oval shaped opening 118 that serves as the female component of a torque lock connector system, the male component being disposed on an end of an elongated flexible rod (not shown) arranged for inspecting from above or below the chimney. The elongated flexible rod is readily available in the marketplace from a number of sources. One such suitable flexible rod is available for sale at https://www.northlineexpress.com/7-8-x-5-proflex-rod-with-torque-lock-connector html. Such flexible rods are often provided for sale with the torque lock connectors described herein installed thereon. The flexible rods can be of any suitable length and thickness, 5 feet in length by ⅞″ in thickness, and may be formed of any suitable material, e.g., heavy duty polypropylene. Such flexible rods are suitable for going through 45° bends, offsets, breeches or thimbles.

The description herein is intended to illustrate possible implementations of the present invention and is not restrictive. While this disclosure has been made in connection with specific forms and embodiments thereof, it will be appreciated that various modifications other than those discussed above may be resorted to without departing from the spirit or scope of the claimed invention. Such variations, modifications, and alternatives will become apparent to the skilled artisan upon review of the disclosure. For example, functionally equivalent elements or method steps may be substituted for those specifically shown and described, and certain features may be used independently of other features, and in certain cases, particular locations of elements or sequence of method steps may be reversed or interposed, all without departing from the spirit or scope of the invention as defined herein. The scope of the claimed invention should therefore be determined with reference to the description above along with their full range of equivalents.

What is claimed is:

1. A device for visually inspecting one or more internal side walls of a generally vertically erected structure to detect a defect or a deposit, said device comprising:
a. a protective shell for housing a camera and a light source therein;
b. a cap attached to said protective shell;
c. a positioning assembly disposed on said cap to maintain said protective shell positioned a predetermined distance from the interior wall of the generally vertically erected structure;
d. a rod mount positioned beneath said protective shell and arranged for attaching an extension rod thereto for controllably raising and lowering said device within the generally vertically erected structure; and,
e. a clamp arranged for retaining a battery pack to said protective shell, the battery pack providing power to said light source.

2. The device of claim 1, wherein said positioning assembly comprises at least three arms attached to and extending radially from said cap.

3. The device of claim 2, wherein said at least three arms are non-rigid rods.

4. The device of claim 1, additionally comprising a longitudinal axis, and wherein said at least three arms extend normal to said longitudinal axis.

5. The device of claim 1, wherein said camera is an industrial endoscope camera in wireless communication with a smart phone.

6. The device of claim 1, wherein the generally vertically erected structure includes four interior walls forming a rectangular cross-section and wherein said protective shell housing comprises a rectangular cross-section substantially smaller than the cross-section of the generally vertically erected structure.

7. The device of claim 1, wherein said cap includes a circular cross-section.

8. The device of claim 3, wherein said at least three arms comprises three arms spaced apart from each other by approximately 120 degrees.

9. The device of claim 4, wherein said at least three arms comprises four arms spaced apart from each other by approximately 90 degrees.

10. The device of claim 3, wherein the diameter of each of said at least three arms is about ⅝ to ¾ inches.

11. The device of claim 1, wherein said camera is selected from the group consisting of a high definition camera, a thermal imaging camera, and an infra-red camera.

12. The device of claim 1, wherein said protective shell further comprises an observation bore for retaining the camera therein, and a light source bore for retaining the light source therein.

13. The device of claim 12, wherein said light source bore is larger in diameter than said observation bore.

14. The device of claim 13, additionally comprising a camera sleeve adapter arranged to fit snugly within said observation bore, said camera sleeve adapter including an interior shaped to house differently shaped and sized cameras therein.

15. The device of claim 14, wherein said interior is shaped to accommodate a camera having a cross-section selected from the group consisting of a square cross-section, a round cross section, an oval cross-section, and a triangular cross-section.

16. The device of claim 15, additionally comprising a light source sleeve adapter arranged to fit snugly within said light source bore, said light source sleeve adapter including an interior shaped to house differently shaped and sized light sources therein.

17. The device of claim 16, wherein said interior is shaped to accommodate a light source having a cross-section selected from the group consisting of a square cross-section, a round cross section, an oval cross-section, and a triangular cross-section.

18. The device of claim 1, wherein said rod mount additionally comprises a receptacle arranged for mating with a horizontal mounting head disposed on said protective shell to enable viewing of an internal side walls of a generally vertically erected structure.

19. The device of claim 18, wherein said protective shell additionally comprises a vertical mounting head located approximately 90 degrees from said horizontal mounting head, and wherein said receptacle is arranged for mating with said vertical mounting head to enable viewing in a vertical direction.

20. The device of claim 1, wherein said rod mount attaches to said extension rod by a torque lock connector.
